(19) United States
(12) Patent Application Publication
(10) Pub. No.: US 2026/0299886 A1
(43) Pub. Date: Oct. 1, 2026

(54) LOGARITHMIC OPERATOR DEVICE HAVING HIGH ACCURACY

(71) Applicant: SigmaStar Technology Ltd., Xiamen (CN)

(72) Inventors: Yue Kai CAI, Shanghai (CN); Hou Yu WANG, Shanghai (CN)

(21) Appl. No.: 19/417,587

(22) Filed: Dec. 12, 2025

(30) Foreign Application Priority Data
Mar. 25, 2025 (CN) 202510360596.4

(51) Int. Cl. G06F 7/556; G06F 5/01

(52) U.S. Cl. CPC G06F 7/556; G06F 5/01

(57) ABSTRACT

A logarithmic operator device includes a memory, a register, a lookup table (LUT) circuit and a data conversion circuit. The memory stores input data. The register stores a plurality of offset values. The data conversion circuits reads the input data from the memory, identifies a most-significant-bit (MSB) position having a specific logical value from the input data, selects a first offset value from the offset values according to the MSB position, and shifts the input data according to the MSB position to generate shifted data. The LUT circuit selects first preprocessed data from a plurality of sets of preprocessed according to the shifted data. The data conversion circuit further generates a logarithmic operation output corresponding to the input data according to the first preprocessed data and the first offset value.

This application claims the benefit of China application Serial No. CN202510360596.4, filed on Mar. 25, 2025, the subject matter of which is incorporated herein by reference.

### BACKGROUND OF THE INVENTION

### Field of the Invention

The present application relates to a logarithmic operator device, and more particularly to a logarithmic operator device having high accuracy.

### Description of the Related Art

Logarithmic operations are extensively applied in fields such as signal analysis and data compression. However, the slope of change of a logarithmic function in some numerical ranges (for example, for values less than 0.5) may be overly large, such that circuit implementations may become quite challenging. As a result, calculation accuracy may be sacrificed to a partial extent during a logarithmic operation performed by a logarithmic operator sub-circuit in existing techniques. On the other hand, in order to enhance operation accuracy to a higher level, a circuit with a greater quantization bandwidth needs to be used, and data instructions capable of processing a large number of bits need to be called for calculations. Thus, in addition to significantly increasing overall hardware costs, processing efficiency may also be degraded.

### SUMMARY OF THE INVENTION

In some embodiments, it is an object of the present application to provide a logarithmic operator device having high accuracy so as to improve the issues of the prior art.

In some embodiments, the logarithmic operator device includes a memory, a register, a look-up table (LUT) circuit and a data conversion circuit. The memory stores input data. The register stores a plurality of offset values. The data conversion circuit reads the input data from the memory, identifies a most-significant-bit (MSB) position having a specific logical value from the input data, selects a first offset value from the plurality of offset values according to the MSB position, and shifts the input data according to the MSB position to generate shifted data. The LUT circuit selects first preprocessed data from a plurality of sets of preprocessed data according to the shifted data. The data conversion circuit further generates a logarithmic operation output corresponding to the input data according to the first preprocessed data and the first offset value.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a logarithmic operator device according to some embodiments of the present application.

FIG. 2 is an operation flowchart of the logarithmic operator device in FIG. 1 according to some embodiments of the present application.

FIG. 3 is a schematic diagram of the input data and shifted data in FIG. 1 according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

Some embodiments of the present application relate to a logarithmic operator device able to perform logarithmic operations. In some embodiments, a neural network model often uses logarithmic operations for training of audios or images, which may be utilized to compress a dynamic range of audio data or image data to more easily process and analyze compressed data. Thus, in some embodiments, the logarithmic operator device of the present invention is, for example but not limited to, applicable to or integrated with neural network applications or related devices thereof.

The mathematical concept of the logarithmic operator device of some embodiments of the present application is first described below. According to the mathematic definition of a logarithmic operator, equation (1) below can be obtained:

$$y = {log}_{2} ( x ) = {log}_{2} ( {x}^{′} \times {2}^{e} ) = {log}_{2} ( {x}^{′} ) + e \qquad ( 1 )$$

Wherein, x is input data, y is a logarithmic operation output of input data x, x′×2^{e} is a floating point form of the input data x, x′ is a mantissa of the input data and is designed to be restricted within a predetermined numerical range, and e is a power number. On the basis of the concept of equation (1) above, equation (2) below may be derived:

$$y = {log}_{2} ( x ) = {s}_{2} {q}_{2} = {log}_{2} ( {s}_{1} {q}_{1} ) = {log}_{2} ( \frac{x Max}{{2}^{15}} \times {q}_{1} ) = {log}_{2} ( \frac{x Max}{2} \times \frac{2}{{2}^{15}} \times {q}_{1} ) = {log}_{2} ( \frac{x Max}{2} \times \frac{2}{{2}^{15}} \times {q}_{1}^{′} \times {2}^{e} ) = {log}_{2} ( \frac{x Max}{2} \times {2}^{e} ) + {log}_{2} ( \frac{2}{{2}^{15}} \times {q}_{1}^{′} ) \qquad ( 2 )$$

Wherein, equation (2) takes 16-bit data for example, s₂ is a quantization interval of an output, s₁ is a quantization interval of an input, q₁ and q₂ are individually quantized data (more specifically, q₁ is shifted input data, and q₂ may be quantized output data), xMax is an upper limit of the input data x,

$${q}_{1}^{′}$$

is a new fixed point number obtained by left-shifting the most significant bit (MSB) of q₁ by the number of quantization bits (for example, left shifting by 16 bits), and the power number e is less than 0.

In some embodiments, the logarithmic operator device is configured to perform operations for the fixed point number

$${q}_{1}^{′} .$$

In this Case, equation (2) may be organized as equation (3) below, and equation (4) may be obtained on the basis of equation (2) and equation (3):

$${log}_{2} ( \frac{x Max}{2} \times {2}^{e} ) + {s}_{2} {log}_{2} ( {q}_{1}^{′} ) \qquad ( 3 )$$

$${q}_{2} = \frac{{log}_{2} ( \frac{x Max}{2} \times {2}^{e} )}{{s}_{2}} + {log}_{2} ( {q}_{1}^{′} ) = bias + {log}_{2} ( {q}_{1}^{′} ) \qquad ( 4 )$$

In equation (4), bias is an offset value to be described below and corresponds to a specific

$${log}_{2} ( {q}_{1}^{′} )$$

and is equal to

$$\frac{{log}_{2} ( \frac{x Max}{2} \times {2}^{e} )}{{s}_{2}} .$$

In some embodiments, the offset value bias may be calculated beforehand in an offline stage. Similarly, in some embodiments,

$${log}_{2} ( {q}_{1}^{′} )$$

may also be calculated beforehand in an offline stage.

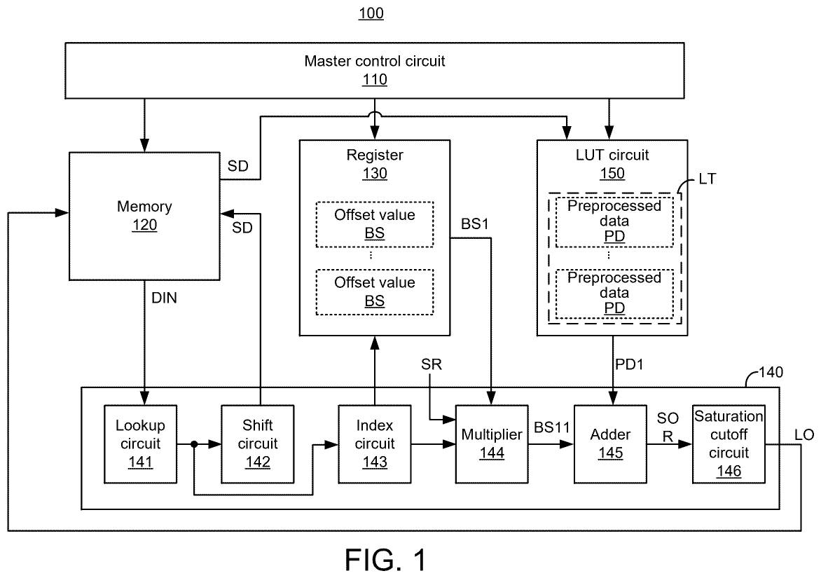

FIG. 1 shows a schematic diagram of a logarithmic operator device 100 according to some embodiments of the present application. The logarithmic operator device 100 includes a master control circuit 110, a memory 120, a register 130, a data conversion circuit 140 and a lookup table (LUT) circuit 150. In some embodiments, the master control circuit 110 may configure beforehand related data and/or data values (e.g. input data DIN stored in the memory 120, a plurality of offset values BS in the register 130, and a lookup table LT in the LUT circuit 150) in the memory 120, the register 130 and the LUT circuit 150 according to statistical information provided by other circuits (for example but not limited to, a processing circuit executing a neural network model) or user requirements.

In some embodiments, the memory 120 may be, for example but not limited to, an L2 memory. In some embodiments, the memory 120 may be, for example but not limited to, a static random access memory (SRAM). The memory 120 may be configured by the master control circuit 110 to store the input data DIN, and store shifted data SD generated by the data conversion circuit 140 in the subsequent operation process.

In some embodiments, the register 130 may be, for example but not limited to, a shift register. The register 130 may store the plurality of offset values BS. In some embodiments, the plurality of offset values BS correspond to the bias in equation (4) above. As described above, in some embodiments, a plurality of offset values BS corresponding to a plurality of different fixed point numbers

$${q}_{1}^{′}$$

may be obtained beforehand by means of computer analysis tools or computer simulation software operations, and information of these offset values BS may be stored by the register 130.

In some embodiments, with the configuration of the master control circuit 110, the LUT circuit 150 may store the lookup table LT, which contains operation results (subsequently referred to as a plurality of sets of preprocessed data PD, which corresponds to different fixed point numbers) of the function

$${log}_{2} ( {q}_{1}^{′} )$$

in equation (4). The LUT circuit 150 may select one set of preprocessed data corresponding to the input data DIN from the plurality of sets of preprocessed data (subsequently referred to as first preprocessed data PD1) contained by the lookup table LT according to the shifted data SD (stored in the memory 120) generated by the data conversion circuit 140, and provide the first preprocessed data PD1 to the data conversion circuit 140.

The data conversion circuit 140 is coupled to the memory 120, the register 130 and the LUT circuit 150. The data conversion circuit 140 may read the input data DIN from the memory 120, identify a most significant bit (MSB) position having a specific logical value in the input data DIN, select a corresponding offset value (subsequently referred to as a first offset value BS1) from the plurality of offset values BS in the register 130 according to the MSB position, shift the input data DIN according to the MSB position to generate the shifted data SD, and generate a logarithmic operation output LO corresponding to the input data DIN according to the shifted data SD and the first preprocessed data PD1. Accordingly, the data conversion circuit 140 may store the logarithmic operation output LO to the memory 120.

In some embodiments, the data conversion circuit 140 may include a lookup circuit 141, a shift circuit 142, an index circuit 143, a multiplier 144, an adder 145 and a saturation cutoff circuit 146. The lookup circuit 141 may read the input data DIN from the memory 120, and identify the MSB position having a specific logical value (for example, logic 1) in the input data DIN. The shift circuit 142 performs a left shift on the input data DIN according to the MSB position to generate the shifted data SD, wherein the number of bits by which the input data DIN is left-shifted is determined according to the MSB position and a predetermined number of bits (which may, for example, be associated with, but not limited to, a quantization bit width or a quantization resolution of the input data DIN). The shift circuit 142 may store the shifted data SD to the memory 120, so that the LUT circuit 150 may select the first preprocessed data PD1 according to the shifted data SD. The index circuit 143 determines a shift number according to the MSB position identified by the lookup circuit 141 and the information of the predetermined number of bits, selects the first offset value BS1 from the plurality of offset values BS in the register 130 according to the MSB position, and transmits the first offset value BS1 to the multiplier 144 via the register 130.

As described above, the plurality of offset values BS may be determined beforehand and stored in the register 130. In some embodiments, if a numerical range of the plurality of offset values BS exceeds a range representable by the quantization bit width (for example, but not limited to, 16 bits) of the input data DIN, the plurality of offset values BS need to be firstly downsized so that the plurality of offset values BS may be represented as 16-bit data. In this case, the multiplier 144 may multiply the first offset value BS1 by a scaling ratio SR to generate a corrected offset value BS11 (that is, restoring the first offset value BS1 to an original value). In one embodiment, the scaling ratio SR is allocated to the multiplier 144 by the master control circuit 110. The adder 145 may add the corrected offset value BS11 and the first preprocessed data PD1 to generate an operation result SOR. Alternatively, if the numerical range of the plurality of offset values BS does not exceed the range representable by the quantization bit width, the adder 145 may add the first offset value BS1 and the first preprocessed data PD1 to generate the operation result SOR (which is equivalent to that the scaling ratio SR is 1).

The saturation cutoff circuit 146 performs a right shift on the operation result SOR to generate the logarithmic operation output LO, wherein the number of bits by which the operation result SOR is right-shifted is equal to the number of bits of the input data DIN. More specifically, if the input data DIN is 16-bit data, the saturation cutoff circuit 146 may right-shift the operation result SOR by 16 bits, and output a portion of least significant bits (LSBs) in the shifted operation result SOR as the logarithmic operation output LO, wherein the number of bits of the portion of LSBs is equal to the number of bits of the input data DIN. In other words, if the input data DIN is 16-bit data, the saturation cutoff circuit 146 may output the last 16 bits (that is, the portion of LSBs above) in the shifted operation result SOR as the logarithmic operation output LO.

It should be noted that, in some embodiments, the lookup circuit 141, the shift circuit 142, the index circuit 143, the multiplier 144, the adder 145 and the saturation cutoff circuit 146 are primarily distinguished in terms of functions and corresponding operations. In actual applications, one or more of the circuits above may be integrated into a same processing circuit, or one or more of the circuits above may share some circuit hardware. Thus, in different embodiments, the data conversion circuit 140 may be implemented by one or more digital circuits that perform corresponding operations or functions of the plurality of circuits above.

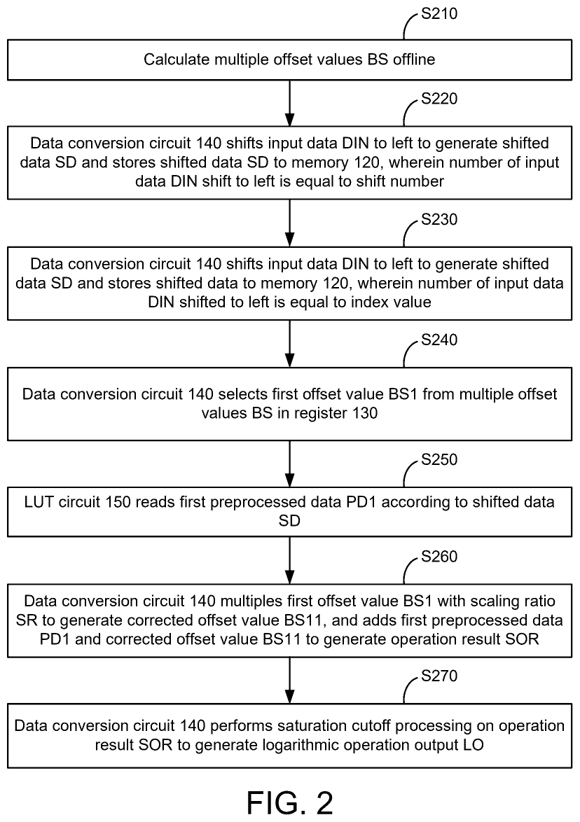

FIG. 2 shows an operation flowchart of the logarithmic operator device 100 in FIG. 1 according to some embodiments of the present application. In operation S210, the plurality of offset values BS are calculated offline. As described above, the plurality of offset values BS of all possible situations may be calculated beforehand and information of the plurality of offset values BS is written to the register 130 by the master control circuit 110. On the other hand, if the plurality of offset values BS exceed the range representable by the number of bits of the input data DIN, the plurality of offset values BS may be downsized according to the scaling ratio SR, and the plurality of downsized offset values BS are stored to the register 130.

In operation S220, the data conversion circuit 140 reads the input data DIN from the memory 120, identifies the MSB position having a specific logical value in the input data DIN, and accordingly determines the shift number. In some embodiments, operation S220 may be performed primarily by the lookup circuit 141 in FIG. 1.

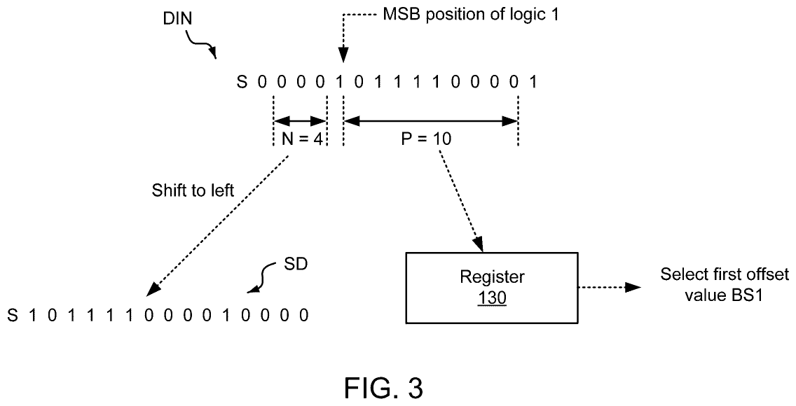

Details of operation S220 are to be described with reference to FIG. 3. FIG. 3 shows a schematic diagram of the input data DIN and the shifted data SD in FIG. 1 according to some embodiments of the present application. In this example, the number of bits of the input data DIN is 16, and the input data DIN is 0x05e1, wherein the 16-bit data is S000010111100001 and S is a symbol bit. In some embodiments, since a logarithmic operation is mainly for processing positive numbers, the symbol bit S may be predetermined as logic 0. In this example, in the input data DIN, the MSB position having a specific logical value (for example, logic 1) is the 10th bit. In this example, the data conversion circuit 140 may record a value P corresponding to the MSB position as 10, and determine a shift number N as 4 according to the value P and the predetermined number of bits above. That is, in this example, the predetermined number of bits is 14, and the shift number N is obtained by subtracting the value P (indicating the MSB position above) from the predetermined number of bits (that is, N=14−P=14−10=4). In some embodiments, the value of the predetermined number of bits is configured for identifying the number of bits to be left-shifted in the input data, so as to limit the mantissa corresponding to the input data DIN within a predetermined numerical range (for example, 1 to 2 or 0.5 to 1; 1 to 2 in this example). In some special circumstances, if the input data DIN is 0, the value P may be set to 0, and the shift number N is especially set to 15.

Again referring to FIG. 2, in operation S230, the data conversion circuit 140 performs a left shift on the input data DIN to generate the shifted data SD, and stores the shifted data SD to the memory 120, wherein the number of bits by which the input data DIN is left-shifted is equal to the shift number. In some embodiments, operation S230 may be performed primarily by the shift circuit 142 in FIG. 1.

For example, as shown in FIG. 3, because the shift number N is 4, the data conversion circuit 140 may left shift the input data DIN by 4 bits (while keeping the symbol bit S unchanged) to obtain the shifted data SD (that is, S101111000010000) having a data value 0x05e10.

In operation S240, the data conversion circuit 140 selects the first offset value BS1 from the plurality of offset values BS in the register 130 according to the MSB position. In some embodiments, operation S240 may be performed primarily by the index circuit 143 in FIG. 1. For example, as shown in FIG. 3, the data conversion circuit 140 may also use the value P corresponding to the MSB position as an index value, and read the first offset value BS1 corresponding to the current input data DIN from the register 130 according to this value P. Alternatively, in other embodiments, the data conversion circuit 140 may also read the first offset value BS1 corresponding to the current input data DIN from the register 130 according to the shift number N (which is determined based on the MSB position).

In operation S250, the LUT circuit 150 reads the first preprocessed data PD1 according to the shifted data SD. In some embodiments, the shifted data SD is equivalent to the fixed point number

$${q}_{1}^{′}$$

in equation (4) above, and a lookup table LT of the LUT circuit 150 contains operation results (which are equivalent to a plurality of sets of preprocessed data PD) of the function

$${log}_{2} ( {q}_{1}^{′} )$$

corresponding to a plurality of fixed point numbers

$${q}_{1}^{′} .$$

The LUT circuit 150 may select the first preprocessed data PD1 corresponding to the current input data DIN from the plurality of sets of preprocessed data PD according to the shifted data SD in the memory 120.

In operation S260, the data conversion circuit 140 multiplies the first offset value BS1 by the scaling ratio SR to generate a corrected offset value BS11, and adds the first preprocessed data PD1 and the corrected offset value BS11 to generate the operation result SOR. In some embodiments, operation S260 may be performed primarily by the multiplier 144 and the adder 145 in FIG. 1. As described above, if the plurality of offset values BS are not downsized beforehand, the data conversion circuit 140 may also directly add the first offset value BS1 and the first preprocessed data PD1 to generate the operation result SOR, that is, the scaling ratio SR is equivalent to 1.

In operation S270, the data conversion circuit 140 performs saturation cutoff processing on the operation result SOR to generate the logarithmic operation output LO. In some embodiments, the operation result SOR obtained in operation S260 is 32-bit data. In order to again store the operation result SOR in the form of 16-bit data to the memory 120, the number of bits of the operation result SOR may be converted by means of a shift operation performed by the saturation cutoff circuit 146. When the operation result SOR exceeds a maximum numerical range representable by 16 bits, the saturation cutoff circuit 146 may select a fixed positive number (0x7FFF) or a fixed negative number (0x8001) according to a symbol representative bit of the operation result SOR. If the operation result SOR does not exceed the maximum numerical range representable by 16 bits, the saturation cutoff circuit 146 may output a portion of the last 16 valid bits in the operation result SOR as the logarithmic operation output LO and store the logarithmic operation output LO to the memory 120, wherein the number of bits of the logarithmic operation output LO is equal to the number of bits of the input data DIN (in this example, both are 16-bit). In some embodiments, operation S270 may be performed primarily by the saturation cutoff circuit 146 in FIG. 1.

As described above, if the input data DIN is 16-bit data, the data conversion circuit 140 may saturate and truncate the operation result SOR to 16 bits, and output a processed operation result as the logarithmic operation output LO. Accordingly, the logarithmic operator device 100 completes the logarithmic operation on the input data DIN.

The multiple operations above are merely examples, and are not limited to being performed in the order specified in this example. Without departing from the operation means and ranges of the various embodiments of the present application, additions, replacements, substitutions or omissions may be made to the operations, or the operations may be performed in different orders. For example, to appropriately optimize the logarithmic operator device 100, operation S230 and operation S240 may be performed simultaneously.

In the foregoing example, the input data DIN is 16-bit data. In this case, the plurality of circuits in the logarithmic operator device 100 only need to process 16-bit data (with only the adder 145 being a 32-bit adder), and the specifications of majority of the circuits may then be implemented by 16-bit circuits, thereby reducing hardware costs. Moreover, by limiting the mantissa of the input data DIN within the predetermined numerical range by the data conversion circuit 140, the logarithmic operation result corresponding to the mantissa of the input data DIN may fall within a value interval having a smaller change of slope in the logarithmic function. Thus, the accuracy of approximate value calculations of the lookup table LT established beforehand may be improved, thereby enhancing the computation accuracy of the logarithmic operator device 100.

In conclusion, the logarithmic operator device provided according to some embodiments of the present application is able to enhance the overall operation accuracy by means of limiting the mantissa corresponding to input data to a specific predetermined numerical range. On the other hand, the quantization bit width processed by majority of the circuits in the logarithmic operator device provided according to some embodiments of the present application is consistent with the number of bits of input data, and the number of circuits having a high quantization bit width used can be decreased, thereby reducing overall hardware costs.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A logarithmic operator device, comprising:
a memory, storing input data;
a register, storing a plurality of offset values;
a data conversion circuit, reading the input data from the memory, identifying a most-significant-bit (MSB) position having a specific logical value from the input data, selecting a first offset value from the plurality of offset values according to the MSB position, and shifting the input data according to the MSB position to generate shifted data; and
a lookup table (LUT) circuit, selecting first preprocessed data from a plurality of sets of preprocessed data according to the shifted data,
wherein the data conversion circuit further generates a logarithmic operation output corresponding to the input data according to the first preprocessed data and the first offset value.

2. The logarithmic operator device according to claim 1, wherein the data conversion circuit determines a shift number based on a predetermined number of bits and the MSB position, and selects the first offset value according to the MSB position from the plurality of offset values stored in the register.

3. The logarithmic operator device according to claim 1, wherein the data conversion circuit determines a shift number based on a predetermined number of bits and the MSB position, and selects the first offset value according to the shift number from the plurality of offset values stored in the register.

4. The logarithmic operator device according to claim 2, wherein the data conversion circuit left-shifts the input data to generate the shifted data, and a number of bits by which the input data is left-shifted is equal to the shift number.

5. The logarithmic operator device according to claim 1, wherein the data conversion circuit adds the first preprocessed data and the first offset value to generate an operation result, and performs saturation and truncation processing on the operation result to generate the logarithmic operation output.

6. The logarithmic operator device according to claim 1, wherein the data conversion circuit further multiplies the first offset value with a scaling ratio to generate a corrected offset value, adds the first preprocessed data and the corrected offset value to generate an operation result, and performs saturation and truncation processing on the operation result to generate the logarithmic operation output.

7. The logarithmic operator device according to claim 1, wherein a number of bits of the logarithmic operation output is equal to a number of bits of the input data.

8. The logarithmic operator device according to claim 1, wherein the specific logical value is logic 1.

9. The logarithmic operator device according to claim 1, wherein the data conversion circuit shifts the input data according to the MSB position to generate the shifted data, so as to limit a mantissa in the input data within a predetermined numerical range.

10. The logarithmic operator device according to claim 9, wherein the predetermined numerical range is 1 to 2 or 0.5 to 1.
